(19) United States
(12) Patent Application Publication
(10) Pub. No.: US 2017/0026098 A1
(43) Pub. Date: Jan. 26, 2017

(54) APPARATUS, SYSTEM AND METHOD OF STEERING A DIRECTIONAL ANTENNA

(71) Applicant: INTEL CORPORATION, Santa Clara, CA (US)

(72) Inventors: Alexander Alexandrovich Maltsev, Nizhny Novgorod (RU); Gregory Vladimirovich Morozov, Nizhny Novgorod (RU); Vadim Sergeyevich Sergeyev, Nizhny Novgorod (RU); Alexey Vladimirovich Davydov, Nizhny Novgorod (RU)

(21) Appl. No.: 15/300,798

(22) PCT Filed: Jun. 26, 2014
(86) PCT No.: PCT/IB2014/001660

§ 371 Date: Sep. 30, 2016

(51) Int. Cl. H04B 7/06; H04W 72/00; H04L 5/00; H04B 7/04; H04W 72/04

(52) U.S. Cl. CPC H04B 7/0617; H04B 7/0491; H04W 72/046; H04L 5/0053; H04W 72/0446; H04W 72/005; H04W 84/12

(57) ABSTRACT

Some demonstrative embodiments include apparatuses, systems and/or methods of steering a directional antenna. For example, a transmitter to transmit a beacon via a steerable directional antenna, the beacon including a multi-directional sounding preamble including a plurality of sounding signals transmitted via a respective plurality of directional sectors of the antenna, each sounding signal including a plurality of repetitions of a detection sequence; a receiver to receive one or more responses from one or more respective wireless communication devices via one or more directional sectors of the plurality of directional sectors; and a controller to select the one or more directional sectors to communicate with the one or more wireless communication devices.

### TECHNICAL FIELD

Embodiments described herein generally relate to steering a directional antenna.

### BACKGROUND

A wireless communications network in a millimeter-wave band may provide high-speed data access for users of wireless communication devices.

A steering procedure may be configured to steer a first directional antenna of a wireless communication node, e.g., an access point (AP) or a base station (BS), and a second directional antenna of a mobile device, e.g., a user equipment (UE), towards each other. The steering procedure may be performed, for example, to establish a high throughout communication link between the node and the mobile device at an acceptable communication range between the node and the mobile device.

The first and/or the second directional antennas may use high gain narrow beams. Each of the first and second directional antennas may be able to steer the beams in a large number of different directions. As a result, targeting the beams of the first and second antennas towards each other may be relatively difficult.

Conventional beam steering procedures for the millimeterWave (mmWave) Band require testing each pair of beam configurations, e.g., including a beam of each of the first and second antennas, by sending a full physical frame, which includes a measurement preamble and a data portion to arrange measurements.

It may be required to update beam settings of the first and/or second antennas quite often to maintain a quality of the communication link at the high throughput.

Accordingly, updating the beam settings may consume a long period of time and a large amount of channel resources, and may require testing a large number of beam settings.

### BRIEF DESCRIPTION OF THE DRAWINGS

For simplicity and clarity of illustration, elements shown in the figures have not necessarily been drawn to scale. For example, the dimensions of some of the elements may be exaggerated relative to other elements for clarity of presentation. Furthermore, reference numerals may be repeated among the figures to indicate corresponding or analogous elements. The figures are listed below.

FIG. 1 is a schematic block diagram illustration of a system, in accordance with some demonstrative embodiments.

FIG. 2 is a schematic illustration of a detection scheme, in accordance with some demonstrative embodiments.

FIG. 3A is a schematic illustration of a first timing scheme of a transmission of a response from a mobile device to a wireless communication node, in accordance with some demonstrative embodiments.

FIG. 3B is a schematic illustration of a second timing scheme of a transmission of a response from a mobile device to a wireless communication node, in accordance with some demonstrative embodiments.

FIG. 4 is a schematic flow chart illustration of a method of steering a directional antenna of a wireless communication node, in accordance with some demonstrative embodiments.

FIG. 5 is a schematic flow chart illustration of a method of steering a directional antenna of a mobile device, in accordance with some demonstrative embodiments.

FIG. 6 is a schematic illustration of a product of manufacture, in accordance with some demonstrative embodiments.

### DETAILED DESCRIPTION

In the following detailed description, numerous specific details are set forth in order to provide a thorough understanding of some embodiments. However, it will be understood by persons of ordinary skill in the art that some embodiments may be practiced without these specific details. In other instances, well-known methods, procedures, components, units and/or circuits have not been described in detail so as not to obscure the discussion.

Discussions herein utilizing terms such as, for example, “processing”, “computing”, “calculating”, “determining”, “establishing”, “analyzing”, “checking”, or the like, may refer to operation(s) and/or process(es) of a computer, a computing platform, a computing system, or other electronic computing device, that manipulate and/or transform data represented as physical (e.g., electronic) quantities within the computer's registers and/or memories into other data similarly represented as physical quantities within the computer's registers and/or memories or other information storage medium that may store instructions to perform operations and/or processes.

The terms “plurality” and “a plurality”, as used herein, include, for example, “multiple” or “two or more”. For example, “a plurality of items” includes two or more items.

References to “one embodiment”, “an embodiment”, “demonstrative embodiment”, “various embodiments” etc., indicate that the embodiment(s) so described may include a particular feature, structure, or characteristic, but not every embodiment necessarily includes the particular feature, structure, or characteristic. Further, repeated use of the phrase “in one embodiment” does not necessarily refer to the same embodiment, although it may.

As used herein, unless otherwise specified the use of the ordinal adjectives “first”, “second”, “third” etc., to describe a common object, merely indicate that different instances of like objects are being referred to, and are not intended to imply that the objects so described must be in a given sequence, either temporally, spatially, in ranking, or in any other manner.

Some embodiments may be used in conjunction with various devices and systems, for example, a Personal Computer (PC), a desktop computer, a mobile computer, a laptop computer, a notebook computer, a tablet computer, a server computer, a handheld computer, a handheld device, a Personal Digital Assistant (PDA) device, a handheld PDA device, an on-board device, an off-board device, a hybrid device, a vehicular device, a non-vehicular device, a mobile or portable device, a consumer device, a non-mobile or non-portable device, a wireless communication station, a wireless communication device, a wireless Access Point (AP), a wired or wireless router, a wired or wireless modem, a video device, an audio device, an audio-video (A/V) device, a wired or wireless network, a wireless area network, a Wireless Video Area Network (WVAN), a Local Area Network (LAN), a Wireless LAN (WLAN), a Personal Area Network (PAN), a Wireless PAN (WPAN), and the like.

Some embodiments may be used in conjunction with devices and/or networks operating in accordance with existing Wireless-Gigabit-Alliance (WGA) specifications (Wireless Gigabit Alliance, Inc WiGig MAC and PHY Specification Version 1.1, April 2011, Final specification) and/or future versions and/or derivatives thereof, devices and/or networks operating in accordance with existing IEEE 802.11 standards (IEEE 802.11-2012, IEEE Standard for Information technology—Telecommunications and information exchange between systems Local and metropolitan area networks—Specific requirements Part 11: Wireless LAN Medium Access Control (MAC) and Physical Layer (PHY) Specifications, Mar. 29, 2012; IEEE802.11 task group ac (TGac) (“IEEE802.11-09/0308r12—TGac Channel Model Addendum Document”); IEEE 802.11 task group ad (TGad) (IEEE P802.11ad-2012, IEEE Standard for Information Technology—Telecommunications and Information Exchange Between Systems—Local and Metropolitan Area Networks—Specific Requirements—Part 11: Wireless LAN Medium Access Control (MAC) and Physical Layer (PHY) Specifications—Amendment 3: Enhancements for Very High Throughput in the 60 GHz Band, 28 Dec. 2012)) and/or future versions and/or derivatives thereof, devices and/or networks operating in accordance with existing Wireless Fidelity (WiFi) Alliance (WFA) Peer-to-Peer (P2P) specifications (WiFi P2P technical specification, version 1.2, 2012) and/or future versions and/or derivatives thereof, devices and/or networks operating in accordance with existing cellular specifications and/or protocols, e.g., 3rd Generation Partnership Project (3GPP), 3GPP Long Term Evolution (LTE) and/or future versions and/or derivatives thereof, devices and/or networks operating in accordance with existing WirelessHD™ specifications and/or future versions and/or derivatives thereof, units and/or devices which are part of the above networks, and the like.

Some embodiments may be used in conjunction with one way and/or two-way radio communication systems, cellular radio-telephone communication systems, a mobile phone, a cellular telephone, a wireless telephone, a Personal Communication Systems (PCS) device, a PDA device which incorporates a wireless communication device, a mobile or portable Global Positioning System (GPS) device, a device which incorporates a GPS receiver or transceiver or chip, a device which incorporates an RFID element or chip, a Multiple Input Multiple Output (MIMO) transceiver or device, a Single Input Multiple Output (SIMO) transceiver or device, a Multiple Input Single Output (MISO) transceiver or device, a device having one or more internal antennas and/or external antennas, Digital Video Broadcast (DVB) devices or systems, multi-standard radio devices or systems, a wired or wireless handheld device, e.g., a Smartphone, a Wireless Application Protocol (WAP) device, or the like.

Some embodiments may be used in conjunction with one or more types of wireless communication signals and/or systems, for example, Radio Frequency (RF), Infra Red (IR), Frequency-Division Multiplexing (FDM), Orthogonal FDM (OFDM), Time-Division Multiplexing (TDM), Time-Division Multiple Access (TDMA), Extended TDMA (E-TDMA), General Packet Radio Service (GPRS), extended GPRS, Code-Division Multiple Access (CDMA), Wideband CDMA (WCDMA), CDMA 2000, single-carrier CDMA, multi-carrier CDMA, Multi-Carrier Modulation (MDM), Discrete Multi-Tone (DMT), Bluetooth®, Global Positioning System (GPS), Wi-Fi, Wi-Max, ZigBee™, Ultra-Wideband (UWB), Global System for Mobile communication (GSM), 2G, 2.5G, 3G, 3.5G, 4G, Fifth Generation (5G) mobile networks, 3GPP, Long Term Evolution (LTE), LTE advanced, Enhanced Data rates for GSM Evolution (EDGE), or the like. Other embodiments may be used in various other devices, systems and/or networks.

The term “wireless device”, as used herein, includes, for example, a device capable of wireless communication, a communication device capable of wireless communication, a communication station capable of wireless communication, a portable or non-portable device capable of wireless communication, or the like. In some demonstrative embodiments, a wireless device may be or may include a peripheral that is integrated with a computer, or a peripheral that is attached to a computer. In some demonstrative embodiments, the term “wireless device” may optionally include a wireless service.

The term “communicating” as used herein with respect to a communication signal includes transmitting the communication signal and/or receiving the communication signal. For example, a communication unit, which is capable of communicating a communication signal, may include a transmitter to transmit the communication signal to at least one other communication unit, and/or a communication receiver to receive the communication signal from at least one other communication unit. The verb communicating may be used to refer to the action of transmitting or the action of receiving. In one example, the phrase “communicating a signal” may refer to the action of transmitting the signal by a first device, and may not necessarily include the action of receiving the signal by a second device. In another example, the phrase “communicating a signal” may refer to the action of receiving the signal by a first device, and may not necessarily include the action of transmitting the signal by a second device.

Some demonstrative embodiments may be used in conjunction with a WLAN. Other embodiments may be used in conjunction with any other suitable wireless communication network, for example, a wireless area network, a “piconet”, a WPAN, a WVAN and the like.

Some demonstrative embodiments may be used in conjunction with a wireless communication network communicating over a frequency band of 60 GHz. However, other embodiments may be implemented utilizing any other suitable wireless communication frequency bands, for example, an Extremely High Frequency (EHF) band (the millimeter wave (mmWave) frequency band), e.g., a frequency band within the frequency band of between 20 Ghz and 300 GHZ, a WLAN frequency band, a WPAN frequency band, a frequency band according to the WGA specification, and the like.

The term “antenna”, as used herein, may include any suitable configuration, structure and/or arrangement of one or more antenna elements, components, units, assemblies and/or arrays. In some embodiments, the antenna may implement transmit and receive functionalities using separate transmit and receive antenna elements. In some embodiments, the antenna may implement transmit and receive functionalities using common and/or integrated transmit/receive elements. The antenna may include, for example, a phased array antenna, a single element antenna, a set of switched beam antennas, and/or the like.

The phrase “access point” (AP), as used herein, may include an entity that contains one station (STA) and provides access to distribution services, via the WM for associated STAs.

The phrases “directional multi-gigabit (DMG)” and “directional band” (DBand), as used herein, may relate to a frequency band wherein the Channel starting frequency is above 45 GHz. In one example, DMG communications may involve one or more directional links to communicate at a rate of multiple gigabits per second, for example, at least 1 Gigabit per second, e.g., 7 Gigabit per second, or any other rate.

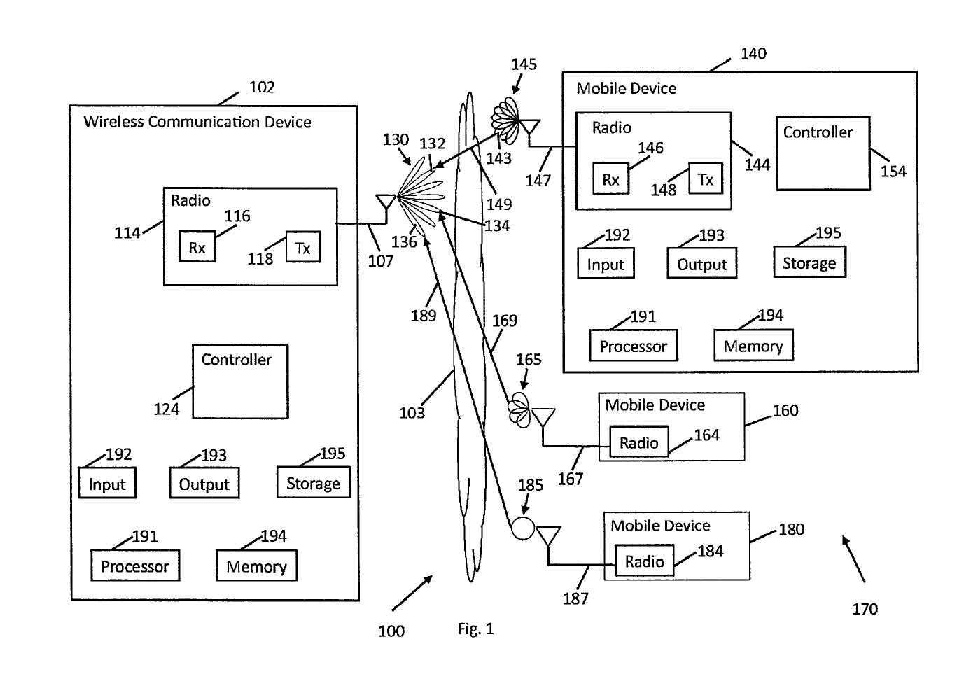

As shown in FIG. 1, in some demonstrative embodiments, system 100 may include one or more wireless communication devices. For example, system 100 may include wireless communication devices 102, 140, 160 and/or 180.

In some demonstrative embodiments, system 100 may include a wireless communication node to communicate with one or more mobile devices 170. For example, wireless communication device 102 may perform the functionality of a node, for example, an AP or a cellular base station, e.g., an evolved Node B (eNB), and/or mobile devices 170 may include devices 140, 160 and/or 180.

In some demonstrative embodiments, device 102 may be configured to provide access to one or more resources, e.g., network resources, the internet and/or the like, and/or one or more services, e.g., Email services and/or the like, to mobile devices 170.

In one example, mobile devices 170 may connect to device 102, for example, to gain access to the one or more resources.

In some demonstrative embodiments, mobile devices 140, 160 and/or 180 may include, for example, a User Equipment (UE), a mobile computer, a laptop computer, a notebook computer, a tablet computer, an Ultrabook™ computer, a mobile internet device, a handheld computer, a handheld device, a storage device, a PDA device, a handheld PDA device, an on-board device, an off-board device, a hybrid device, a consumer device, a vehicular device, a non-vehicular device, a portable device, a mobile phone, a cellular telephone, a PCS device, a mobile or portable GPS device, a DVB device, a relatively small computing device, a non-desktop computer, a “Carry Small Live Large” (CSLL) device, an Ultra Mobile Device (UMD), an Ultra Mobile PC (UMPC), a Mobile Internet Device (MID), an “Origami” device or computing device, a device that supports Dynamically Composable Computing (DCC), an “Origami” device or computing device, a video device, an audio device, an A/V device, a gaming device, a media player, a Smartphone, or the like.

In some demonstrative embodiments, devices 102, 140, 160 and/or 180 may also include, for example, a processor 191, an input unit 192, an output unit 193, a memory unit 194, and/or a storage unit 195. Device 102 may optionally include other suitable hardware components and/or software components. In some demonstrative embodiments, some or all of the components of wireless communication devices 102, 140, 160 and/or 180 may be enclosed in a common housing or packaging, and may be interconnected or operably associated using one or more wired or wireless links. In other embodiments, components of wireless communication devices 102, 140, 160 and/or 180 may be distributed among multiple or separate devices.

Processor 191 includes, for example, a Central Processing Unit (CPU), a Digital Signal Processor (DSP), one or more processor cores, a single-core processor, a dual-core processor, a multiple-core processor, a microprocessor, a host processor, a controller, a plurality of processors or controllers, a chip, a microchip, one or more circuits, circuitry, a logic unit, an Integrated Circuit (IC), an Application-Specific IC (ASIC), or any other suitable multi-purpose or specific processor or controller. For example, processor 191 executes instructions, for example, of an Operating System (OS) of device 102 and/or device 140 and/or of one or more suitable applications.

Memory unit 194 includes, for example, a Random Access Memory (RAM), a Read Only Memory (ROM), a Dynamic RAM (DRAM), a Synchronous DRAM (SD-RAM), a flash memory, a volatile memory, a non-volatile memory, a cache memory, a buffer, a short term memory unit, a long term memory unit, or other suitable memory units. Storage unit 195 include, for example, a hard disk drive, a floppy disk drive, a Compact Disk (CD) drive, a CD-ROM drive, a DVD drive, or other suitable removable or non-removable storage units. For example, memory unit 194 and/or storage unit 195, for example, may store data processed by device 102 and/or device 140.

Input unit 192 may include, for example, a keyboard, a keypad, a mouse, a touch-screen, a touch-pad, a track-ball, a stylus, a microphone, or other suitable pointing device or input device. Output unit 193 may include, for example, a monitor, a screen, a touch-screen, a flat panel display, a Light Emitting Diode (LED) display unit, a Liquid Crystal Display (LCD) display unit, a plasma display unit, Cathode Ray Tube (CRT) display unit, one or more audio speakers or earphones, or other suitable output devices.

In some demonstrative embodiments, wireless communication devices 102, 140, 160 and/or 180 may be capable of communicating content, data, information and/or signals via a wireless medium (WM) 103. In some demonstrative embodiments, wireless medium 103 may include, for example, a radio channel, a cellular channel, a Global Navigation Satellite System (GNSS) Channel, an RF channel, a Wireless Fidelity (WiFi) channel, an IR channel, a Bluetooth (BT) channel, and the like.

In some demonstrative embodiments, WM 103 may include a directional channel. For example, WM 103 may include a millimeter-wave (mmwave) wireless communication channel.

In some demonstrative embodiments, WM 103 may include a DMG channel. In other embodiments WM 103 may include any other directional channel.

In some demonstrative embodiments, devices 102, 140, 160 and 180 may include one or more radios to perform wireless communication between devices 102, 140, 160, 180 and/or one or more other wireless communication devices. For example, device 102 may include a radio 114, device 140 may include a radio 144, device 160 may include a radio 164, and/or device 180 may include a radio 184.

In some demonstrative embodiments, radios 114, 144, 164, and/or 184 may include one or more wireless receivers (Rx) to receive wireless communication signals, RF signals, frames, blocks, transmission streams, packets, messages, data items, and/or data. For example, radio 114 may include a receiver 116, and/or radio 144 may include a receiver 146.

In some demonstrative embodiments, radios 114, 144, 164, and/or 184 may include one or more wireless transmitters (Tx) to send wireless communication signals, RF signals, frames, blocks, transmission streams, packets, messages, data items, and/or data. For example, radio 114 may include a transmitter 118, and/or radio 144 may include a transmitter 148.

In some demonstrative embodiments, radios 114, 144, 164, and/or 184 may include modulation elements, demodulation elements, amplifiers, analog to digital and digital to analog converters, filters, and/or the like. For example, radios 114, 144, 164, and/or 184 may include or may be implemented as part of a wireless Network Interface Card (NIC), and the like.

In some demonstrative embodiments, radios 114, 144, 164, and/or 184 may include, or may be associated with, one or more antennas 107, 147, 167 and/or 187, respectively.

Antennas 107, 147, 167 and/or 187 may include any type of antennas suitable for transmitting and/or receiving wireless communication signals, blocks, frames, transmission streams, packets, messages and/or data. For example, antennas 107, 147, 167 and/or 187 may include any suitable configuration, structure and/or arrangement of one or more antenna elements, components, units, assemblies and/or arrays. Antennas 107, 147, 167 and/or 187 may include, for example, antennas suitable for directional communication, e.g., using beamforming techniques. For example, antennas 107, 147, 167 and/or 187 may include a phased array antenna, a multiple element antenna, a set of switched beam antennas, and/or the like. In some embodiments, antennas 107, 147, 167 and/or 187 may implement transmit and receive functionalities using separate transmit and receive antenna elements. In some embodiments, antennas 107, 147, 167 and/or 187 may implement transmit and receive functionalities using common and/or integrated transmit/receive elements.

In some demonstrative embodiments, antennas 107, 147, 167 and/or 187 may include a steerable directional antenna, which may be steered to one or more directional sectors.

In some demonstrative embodiments, a directional sector of an antenna may be expressed by a direction and width, e.g., an angle, of a beam transmitted by the antenna. In one example, a directional sector may be directed to the north and may have a width of 30 degrees.

In some demonstrative embodiments, antenna 107 may be steered to a plurality of directional sectors 130.

In one example, the plurality of directional sectors 130 may include eight directional sectors. In another example, the plurality of directional sectors 130 may include any other number of directional sectors, e.g., 16, 48, 128, 256, or any other number of directional sectors.

In some demonstrative embodiments, the plurality of directional sectors 130 may be predefined. For example, the plurality of directional sectors 130 may include a predefined number of directional sectors (“fixed sectors”) each having a predefined width and direction.

In other embodiments, the plurality of directional sectors 130 may not be predefined. For example, device 102 may independently and continuously steer one or more directional beams of antenna 107 to cover the plurality of directional sectors, e.g., instead of creating a number of fixed sectors.

In some demonstrative embodiments, antenna 147 may be steered to one or more directional sectors 145, e.g., eight sectors.

In some demonstrative embodiments, antenna 167 may be steered to one or more directional sectors 165, e.g., four sectors.

In some demonstrative embodiments, antenna 187 may include an omnidirectional antenna to cover an omnidirectional sector 185.

In some demonstrative embodiments, antennas 107, 147, 167 and/or 187 may be steered to any other number of directional sectors.

In some demonstrative embodiments, the number of the plurality of directional sectors 130 may be significantly greater than a number of each of directional sectors 145, 165 and/or 185.

In one example, the plurality of directional sectors 130 may include between 8 and 256 sectors, while each of directional sectors 145, 165 and/or 185 may include between 1 and 16 sectors.

In some demonstrative embodiments, a number of directional sectors of an antenna, e.g., the directional sectors of antenna 107, antenna 147, antenna 167, and/or antenna 187, may be based on a width of a directional sector of the antenna. For example, a first number of directional sectors of a first antenna may be greater than a second number of directional sectors of a second antenna, for example, if a first width of the first directional sector of the first directional antenna is narrower than a second width of the second directional sector of the second directional antenna, e.g., if both the first and second antennas cover the same area.

In some demonstrative embodiments, the plurality of directional sectors 130 may include narrow directional sectors and/or beams, and one or more of directional sectors 145, 165 and/or 185 may also include narrow directional sectors and/or beams.

In some demonstrative embodiments, device 102 may include a controller 124 to detect a mobile device 170 and may select a directional sector of the plurality of directional sectors 130, for example, to communicate with the mobile device 170, e.g., as described below.

In some demonstrative embodiments, the mobile device 170 may detect device 102 and may select a directional sector to communicate with device 102. For example, device 140 may include a controller 154 to detect device 102, and to select a directional sector of directional sectors 145 to communicate with device 102, e.g., as described below.

In some demonstrative embodiments, device 102 may select the directional sector of directional sectors 130, and/or device 140 may select the directional sector of directional sectors 145, for example, to enable communication between device 102 and device 140 over a DMG link at a high data rate.

In some demonstrative embodiments, devices 102 and 170 may use a steering procedure to select a first directional sector of the plurality of directional sectors 130 and a second directional sector of mobile device 170, such that the first and second directional sectors may be directed towards each other, for example, to enable a high throughput link between device 102 and mobile device 170.

In some demonstrative embodiments, device 102 and device 140 may not be able to communicate at the high data rate, for example, if the selected directional sector of directional sectors 130 and the selected directional sectors of directional sectors 145 are not directed towards each other.

In some demonstrative embodiments, devices 102 and 170 may be required to test a plurality of pairs of directional sectors, e.g., each pair including a different combination of a first directional sector of directional sectors 130 and a second directional sector of directional sectors 145, for example, to select an optimal pair of directional sectors, which are directed towards each other.

In some demonstrative embodiments, device 102 may be required to test a large number of pairs of directional sectors, for example, if directional sectors 130 and/or directional sectors 145 include a large number of directional sectors.

In one example, the plurality of directional sectors 130 may include 128 directional sectors, and directional sectors 145 may include 8 directional sectors. According to this example, device 102 and device 140 may test 1024 pairs of directional sectors to select the optimal pair of directional sectors.

In some demonstrative embodiments, performing a steering procedure to select optimal beam pairs for communication between device 102 and each of devices 170 may consume a long period of time, for example, if device 102 separately selects an optimal pair of directional sectors to be used to communicate with each mobile device of mobile devices 170.

In one example, mobile devices 170 may include one hundred devices, each device of mobile devices 170 may have between 1 and 16 directional sectors, and the plurality of directional sectors 130 may include 128 directional sectors. According to this example, device 102 may test between 12800 and 204800 pairs of directional sectors to select an optimal pair of directional sectors to communicate with each mobile device of mobile devices 170, for example, if device 102 selects an optimal pair of directional sectors for each device of mobile devices 170 separately.

Some demonstrative embodiments may enable detecting mobile devices 170 and selecting one or more directional sectors of sectors 130 to communicate with the mobile devices 170, e.g., at a reduced time.

Some demonstrative embodiments may enable detecting mobile devices 170 and selecting the one or more directional sectors within a single detection cycle.

Some demonstrative embodiments may enable detecting mobile devices 170 and selecting the one or more directional sectors during a reduced number of beacon intervals, e.g., even during a single beacon interval, e.g., as described below.

In some demonstrative embodiments, transmitter 118 may transmit a beacon via antenna 107.

In some demonstrative embodiments, the beacon may include a multi-directional sounding preamble.

In some demonstrative embodiments, the multi-directional sounding preamble may be utilized to detect mobile devices 170, e.g., instead of using a plurality of test frames, e.g., DMG beacon frames.

In some demonstrative embodiments, the multi-directional sounding preamble may include a plurality of sounding signals.

In some demonstrative embodiments, the plurality of sounding signals may be predefined, and may be known to mobile devices 170.

In some demonstrative embodiments, device 102 may transmit the plurality of sounding signals via respective ones of the plurality of directional sectors 130. For example, transmitter 118 may transmit a sounding signal of the plurality of sounding signals via each directional sector of directional sectors 130.

In some demonstrative embodiments, transmitter 118 may sequentially transmit the plurality of sounding signals.

In some demonstrative embodiments, transmitter 118 may sequentially transmit the plurality of sounding signals during a respective sequence of sounding periods. For example, transmitter 118 may transmit a sounding signal of the plurality of sounding signals during a respective sounding period of the sequence of sounding periods.

In some demonstrative embodiments, the sounding signals may have a periodic structure, which may enable a mobile device 170 to receive the sounding signals using different directional sectors, e.g., as described below.

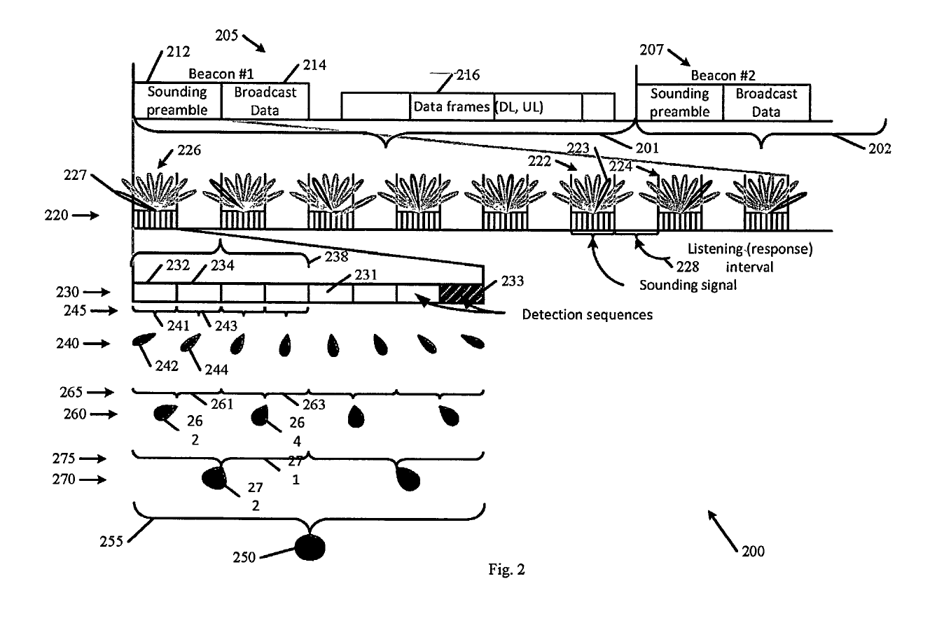

In some demonstrative embodiments, each sounding signal of the plurality of sounding signals may include a plurality of repetitions of a detection sequence, e.g., as described below with reference to FIG. 2.

In some demonstrative embodiments, one or more of mobile devices 170 may receive from device 102 one or more repetitions of the detection sequence corresponding to one or more sounding signals of the plurality of sounding signals.

For example, a first mobile device 170 may receive from device 102 a first repetition of the detection sequence corresponding to a first sounding signal of the plurality of the sounding signals, and/or a second mobile device 170 may receive from device 102 a second repetition of the detection sequence corresponding to a second sounding signal of the plurality of the sounding signals.

In one example, the first sounding signal may correspond to a first directional sector of the plurality of directional sectors 130, which is directed towards the first device, and/or the second sounding signal may correspond to a second directional sector of the plurality of directional sectors 130, which is directed towards the second device.

In some demonstrative embodiments, the mobile device 170 may steer a directional antenna of the mobile device 170 to detect device 102 and/or to receive the one or more repetitions of the detection sequence transmitted from device 102, e.g., as described below. For example, controller 154 may be configured to steer directional antenna 147.

In some demonstrative embodiments, controller 154 may steer directional antenna 147 between the one or more directional sectors 145 during one or more sounding periods of the sequence of sounding periods.

In some demonstrative embodiments, receiver 146 may receive the one or more repetitions of the detection sequence from device 102 via a directional sector 143 of the one or more directional sectors 145. For example, directional sector 143 may be directed towards device 102.

In some demonstrative embodiments, transmitter 148 may transmit a response 149 to device 102 via the directional sector 143, e.g., in response to the one or more repetitions of the detection sequence of the first sounding signal.

In some demonstrative embodiments, transmitter 148 may transmit response 149 via directional sector 143 after the detection of the first sounding signal, for example, prior to the transmission of a subsequent sounding signal.

In some demonstrative embodiments, transmitting response 149 via directional sector 143 may increase reliability of receiving the response, e.g., by device 102, for example, if receiver 146 detects device 102 via directional sector 143.

In some demonstrative embodiments, receiver 146 may receive the one or more repetitions of the detection sequence of the first sounding signal during a first sounding period.

In some demonstrative embodiments, transmitter 148 may transmit response 149 between two consecutive sounding periods, for example, if radio 144 is configured to communicate according to a Time division duplex (TDD) scheme, e.g., as described below.

In other embodiments, transmitter 148 may transmit response 149 during a time period, which may at least partially overlap a sounding period, e.g., if radio 144 is configured to communicate according to a Frequency Division Duplex (FDD) scheme. For example, transmitter 148 may transmit response 149 during the first sounding period.

In some demonstrative embodiments, transmitter 148 may transmit response 149 prior to a second sounding period corresponding to a second sounding signal, which is immediately subsequent to the first sounding period.

In some demonstrative embodiments, transmitter 148 may transmit response 149 during a first response period between the first sounding period and the second sounding period.

In some demonstrative embodiments, transmitter 148 may transmit response 149 to device 102 during a second response period, e.g., different from the first response period, for example, if device 140 performs the detection for all of the plurality of sounding signals and/or for all directional sectors 145 to communicate with device 102.

In some demonstrative embodiments, response 149 may include a plurality of repetitions of a response sequence.

In some demonstrative embodiments, the response sequence may be different from the detection sequence, e.g., as described below.

In some demonstrative embodiments, the response sequence may be longer than the detection sequence, e.g., as described below.

In some demonstrative embodiments, response 149 may indicate an index of the first sounding signal, for example, to enable device 102 to select directional sector 132 to communicate with device 140.

In some demonstrative embodiments, receiver 116 may receive one or more responses from one or more respective mobile devices of devices 170 via one or more directional sectors of the plurality of directional sectors 130.

In some demonstrative embodiments, receiver 116 may receive response 149 between two consecutive sounding periods, for example, if radio 114 is configured to communicate according to a TDD scheme, e.g., as described below.

In other embodiments, receiver 116 may receive response 149 during a time period, which may at least partially overlap a sounding period, e.g., if radio 114 is configured to communicate according to a FDD scheme. For example, receiver 116 may transmit response 149 during the first sounding period.

In some demonstrative embodiments, receiver 116 may receive response 149 from device 140 via a directional sector 132. For example, receiver 116 may receive response 149, e.g., in response to the first sounding signal, and prior to transmission of a second sounding signal, which is subsequent to the first sounding signal.

In some demonstrative embodiments, receiver 116 may receive response 149 during the first response period between the transmission of the first sounding signal and the transmission of the second sounding signal.

In some demonstrative embodiments, receiver 116 may receive one or more other responses from one or more other mobile devices 170 via one or more directional sectors of directional sectors 130. For example, receiver 116 may receive a response 169 from device 160 via directional sector 134, and/or receiver 116 may receive a response 189 from device 180 via directional sector 136. In another example, receiver 116 may receive responses from two or more mobile device 170 via the same directional sector.

In some demonstrative embodiments, receiver 116 may receive response 189 during a second response period, e.g., after the second sounding signal, for example, if device 180 detects device 102 during a sounding period corresponding to the second sounding signal.

In some demonstrative embodiments, device 102 may switch to a reception mode during the response period, for example, to receive response 149 from device 140.

In some demonstrative embodiments, each sounding signal may be configured to indicate to mobile devices 170 an end of the sounding signal.

In some demonstrative embodiments, the sounding signal may be configured to indicate the end of the sounding signal, for example, to ensure that transmission of responses 149, 169 and/or 189 does not overlap with the sounding signal or another sounding signal.

In some demonstrative embodiments, device 102 may fail to receive responses 149, 169 and/or 189, for example, if the transmission of responses 149, 169 and/or 189 overlaps the sounding signal.

In some demonstrative embodiments, the sounding signal may include an indication of an end of the sounding signal, e.g., as described below.

In some demonstrative embodiments, the plurality of repetitions of the detection sequence may include a plurality of repetitions of a first detection sequence and a second detection sequence, e.g., different from the first detection sequence, following the plurality of repetitions of the first detection sequence, for example, to indicate the end of the sounding signal, e.g., as described below with reference to FIG. 2.

In one example, the second detection sequence may have a negative sign or may be phase-rotated with respect to the first detection sequence, for example, to enable a mobile device 170 to detect the end of the sounding signal, while not affecting a detection algorithm of the detection sequence, which may be based on auto-correlation.

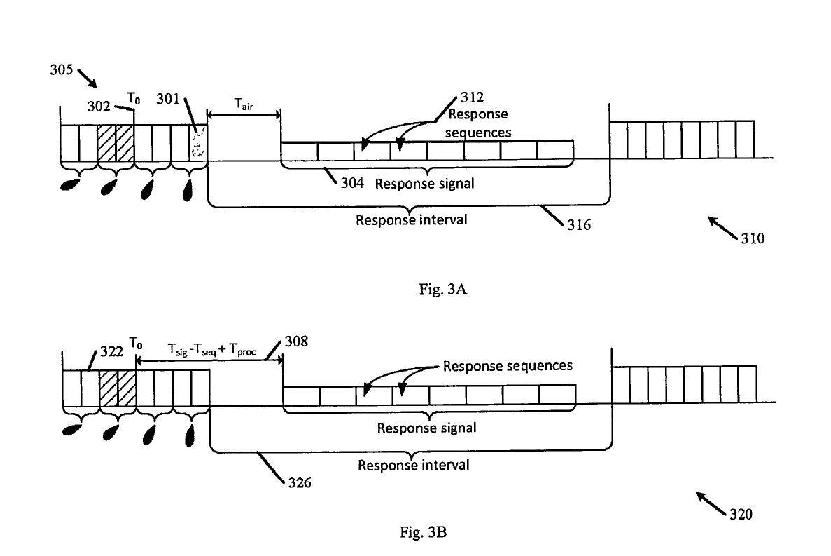

In some demonstrative embodiments, transmitter 148 may transmit the response after receipt of the indication, e.g., as described below with reference to FIG. 3A.

In some demonstrative embodiments, transmitter 148 may transmit the response a predefined delay period after receipt of the one or more repetitions of the detection sequence.

In some demonstrative embodiments, the delay period may be based on a sounding period duration of the sounding signal and a duration of the detection sequence.

In some demonstrative embodiments, the delay period may be equal to or greater than a difference between the sounding period duration and the duration of the detection sequence, e.g., as described below with reference to FIG. 3B.

In some demonstrative embodiments, controller 124 may select one or more directional sectors to communicate with devices 140, 160 and/or 180, e.g., based on the responses from devices 140, 160 and/or 180.

For example, controller 124 may select the directional sector 132 to communicate with device 140 based on response 149, directional sector 134 to communicate with device 160 based on response 169, and/or directional sector 136 to communicate with device 180 based on response 189.

In some demonstrative embodiments, transmitter 118 may broadcast information (“the broadcast information”) to the one or more mobile devices 170 via the one or more selected directional sectors. For example, transmitter 118 may broadcast the information to devices 140, 160 and/or 180 via directional sectors 132, 134 and/or 136, respectively.

In some demonstrative embodiments, the broadcast information may include information corresponding to beam settings of antennas 107, scheduling within beacon interval of device 102 and the like.

In some demonstrative embodiments, the broadcast information may include an identifier of device 102, e.g., a media access control (MAC) address of device 102; capability information corresponding to device 102, e.g., a Modulation and Coding Scheme (MCS) of device 102, a number of MIMO spatial streams of antenna 107, and the like; version information of a wireless communication protocol version utilized by device 102, and/or the like.

In some demonstrative embodiments, transmitter 118 may broadcast the information to the one or more wireless communication devices 170 only after the transmission of all the plurality of sounding signals, and reception of responses from one or more of mobile devices 170.

In some demonstrative embodiments, receiver 146 may receive the broadcast information from wireless communication device 102 via the directional sector 143.

In some demonstrative embodiments, device 102 may transmit to mobile devices 170 timing information corresponding to the sounding preamble, e.g., via a wireless communication channel different from the wireless communication channel used to transmit the beacon, e.g., via a WiFi communication channel, a cellular communication channel and/or the like.

In some demonstrative embodiments, device 140 may detect device 102 based on the timing information. For example, device 140 may limit a time interval for detecting the plurality of sounding signals, based on the timing information.

In some demonstrative embodiments, the timing information may be utilized to increase a probability of device 140 detecting device 102 and/or may reduce the probability of a false detection of device 102.

Reference is made to FIG. 2, which schematically illustrates a detection scheme between a wireless communication node and one or more mobile devices, in accordance with some demonstrative embodiments. For example, the node may perform the functionality of device 102 (FIG. 1), and/or the one or more wireless communication devices may perform the functionality of the one or more wireless communication devices 170 (FIG. 1).

In some demonstrative embodiments, the node may transmit beacons during beacon intervals, for example, to detect the one or more wireless communication devices. For example, the node may transmit a first beacon 205, denoted #1, during a first beacon interval 201; and/or a second beacon 207, denoted #2, during a second, e.g., subsequent, beacon interval 202.

In one example, beacon interval 201 and/or beacon interval 202 may have a duration of approximately 10 milliseconds (ms), or any other duration.

In some demonstrative embodiments, beacon 205 may include a multi-directional sounding preamble 212, followed by broadcast information 214, e.g., as described below. Beacon 205 may be followed by one or more data frames 216, e.g., Uplink (UL) and/or Downlink (DL) data frames.

In some demonstrative embodiments, broadcast information 214 may be transmitted only after transmission of multi-directional sounding preamble 212, e.g., as described below.

In some demonstrative embodiments, multi-directional sounding preamble 212 may include a plurality of sounding signals 220.

In some demonstrative embodiments, the node may transmit the plurality of sounding signals 220 via a plurality of respective directional sectors of a directional antenna of the node, e.g., via sectors 130 (FIG. 1) of antenna 107 (FIG. 1).

In some demonstrative embodiments, the plurality of sounding signals 220 may include a predefined number of sounding signals (“the preamble length”), e.g., 8 sounding signals, 32 sounding signals, 64 sounding signals, 128 sounding signals, 256 sounding signals, or any other number of sounding signals.

In some demonstrative embodiments, the number of the plurality of sounding signals 220 may be based on a number of directional sectors of the directional antenna of the node. For example, the number of the plurality of sounding signals 220 may be based on the number of the plurality of directional sectors 130 (FIG. 1), e.g., each sounding signal of the plurality of sounding signals 220 may be transmitted via a respective directional sector of the plurality of directional sectors 130 (FIG. 1).

As shown in FIG. 2, the plurality of sounding signals 220 may include 8 sounding signals, for example, if the plurality of directional sectors 130 (FIG. 1) includes 8 directional sectors.

As shown in FIG. 2, the plurality of sounding signals 220 may be transmitted utilizing a single beacon, e.g., beacon 205, for example, if the number of directional sectors 130 (FIG. 1) is lesser than or equal to in the preamble length of multi-directional sounding preamble 212.

In some demonstrative embodiments, the plurality of sounding signals 220 may be transmitted utilizing more than one beacon, e.g., beacon 205 and beacon 207, for example, if the number of directional sectors 130 (FIG. 1) is greater than the preamble length of multi-directional sounding preamble 212.

In one example, the number of directional sectors 130 (FIG. 1) may include 256 directional sectors, and the preamble length may include 128 sounding signals. According to this example, the number of the plurality of sounding signals 220 may be 256 signals, and the node may transmit the plurality of sounding signals 220 using beacon 205 and beacon 207, e.g., 128 sounding signals in beacon 205, and 128 sounding signals in beacon 207.

In some demonstrative embodiments, as shown in FIG. 2, the node may transmit the plurality of sounding signals 220 sequentially.

In some demonstrative embodiments, the node may wait for one or more responses from the one or more mobile devices during a response period.

As shown in FIG. 2, a response period may be allocated between each two subsequent sounding signals of the plurality of sounding signals 220.

For example, a response period 228 may be allocated between a sounding signal 222 and a sounding signal 224 subsequent to sounding signal 222.

In one example, the node may receive a response from a mobile device of the one or more mobile devices during response period 228, for example, if the mobile device is located in a coverage area of a directional sector 223, which is used to transmit sounding signal 222.

In some demonstrative embodiments, the node may receive the response from the mobile device during response period 228, for example, if the node is using the TDD scheme.

In other embodiments, the node may receive the response during the transmission of sounding signal 222, for example, if the node is using the FDD scheme.

In some demonstrative embodiments, each sounding signal of the plurality of sounding signals 220, e.g., a sounding signal 226, may have one or more properties to enable the one or more mobile devices to distinguish sounding signal 226, for example, from a noise and/or other signals transmitted, e.g., in the same band.

In some demonstrative embodiments, sounding signal 226 may be constructed as a repetition of a detection sequence 231, which may have increased auto-correlation properties.

As shown in FIG. 2, sounding signal 226 may include a plurality of repetitious 230 of detection sequence 231.

In some demonstrative embodiments, the plurality of repetitious 230 may enable the one or more mobile devices to effectively detect the node.

In one example, the plurality of repetitious 230 may enable the one or more mobile devices to effectively detect the node, for example, even if the one or more mobile devices have different antenna characteristic, e.g., different numbers of directional sectors.

In another example, the plurality of repetitious 230 may enable the one or more mobile devices to effectively detect the node, for example, even if the one or more mobile devices have different receive conditions, e.g., if the one or more mobile devices are placed at different distances from the node.

In some demonstrative embodiments, a first mobile device may include a first antenna, for example, a highly directional antenna, e.g., an antenna having an increased number of directional sectors, and/or may have increased receive conditions, e.g., if the first mobile device is located near the node. For example, the first mobile device may perform the functionality of device 140 (FIG. 1).

In some demonstrative embodiments, the first mobile device may be able to detect the node by testing a single repetition of detection sequence 231 per each directional sector of the first antenna. For example, the first mobile device may be able to test the single repetition of detection sequence 231, e.g., if detection sequence 231 is received at the first mobile device with an increased signal strength.

In some demonstrative embodiments, using the single repetition of detection sequence 231 to detect the node may enable the first mobile device to test an increased number of directional sectors of the first antenna, e.g., while receiving sounding signal 226.

As shown in FIG. 2, the first mobile device may steer the first antenna between a plurality of directional sectors 240 during one or more respective detection periods 245.

For example, the first mobile device may steer the first antenna to a directional sector 242 during a detection period 241, and/or the first mobile device may steer the first antenna to a second directional sector 244 during a detection period 243.

As shown in FIG. 2, the first antenna may include 8 directional sectors. In other embodiments the first antenna may include any other number of sectors of a highly directional antenna, e.g., 16 directional sectors.

As shown in FIG. 2, the first mobile device may test all, e.g., 8 directional sectors, of the plurality of directional sectors 240 using sounding signal 226.

For example, the first mobile device may test the directional sector 242 with a directional sector 227 of the node, via which sounding signal 226 is transmitted, using a repetition 232 of the detection sequence during detection period 241, and/or the first mobile device may test directional sector 244 with directional sector 227 using a repetition 234 of the detection sequence during detection period 243.

In some demonstrative embodiments, a second mobile device may include a second antenna, for example, an omni-directional antenna, e.g., an antenna to cover an omni-directional sector, and/or may have poor receive conditions, e.g., if the second mobile device is located far away from the node. For example, the second mobile device may perform the functionality of device 180 (FIG. 1).

In some demonstrative embodiments, the second antenna may not be able to detect the node, for example, by testing a single repetition of detection sequence 231. For example, the second antenna may not be able to use the single repetition of detection sequence 231, e.g., if detection sequence 231 is received at the second mobile device with a weak signal strength.

In some demonstrative embodiments, the second mobile device may utilize two or more, e.g., all, repetitions of the plurality of repetitions 230 to detect the node.

For example, the second mobile device may utilize all repetitions of the plurality of repetitions 230, for example, to combine all the detection sequences of the plurality of repetitions 230, which may increase a probability of detecting the node.

As shown in FIG. 2, the second antenna may be at an omnidirectional sector 250 during a detection period 255.

As shown in FIG. 2, detection period 255 may be during all the sounding period of sounding signal 226.

As shown in FIG. 2, the second mobile device may test omnidirectional sector 250 with directional sector 227 during detection period 255 using all the plurality of repetitions 230 of detection sequence 231.

In some demonstrative embodiments, testing of omnidirectional sector 250 with directional sector 227 using all the plurality of repetitions 230 of detection sequence 231 may enable detection of the node by the second mobile device, for example, even if the second mobile device has poor receive conditions, e.g., by combining all detection sequences 231 of the plurality of repetitions 230.

In some demonstrative embodiments, a third mobile device may include a third antenna, for example, a directional antenna, e.g., an antenna having a few directional sectors, and/or may have intermediate receive conditions, e.g., greater than the receive conditions of the second mobile device and/or lesser than the receive conditions of the first mobile device. For example, the third mobile device may perform the functionality of device 160 (FIG. 1).

In some demonstrative embodiments, the third mobile device may not be able to detect the node, by testing a single repetition of detection sequence 231 per each directional sector of the third antenna. However, the third mobile device may be able to use a combination of two or more repetitions of detection sequence 231 to detect the node.

For example, the third mobile device may not be able to use the single repetition of the detection sequence 231, for example, if the third antenna is not able to distinguish the single repetition of detection sequence 231 from noise. However, a combination of two or more repetitions of detection sequences 231 enable the third mobile device to differentiate the detection sequence 231 from the noise.

In some demonstrative embodiments, the third mobile device may utilize two or more, e.g., less than all, repetitions of the plurality of repetitions 230 to detect the node.

In some demonstrative embodiments, utilizing the two or more repetitions may enable to test more than one directional sector of the third antenna per sounding signal, for example, compared to the second antenna, in which only one sector, e.g., the omnidirectional sector 250, is tested using sounding signal 226.

In one example, the third mobile device may steer the third antenna between a plurality of directional sectors 260 during a plurality of respective detection periods 265.

As shown in FIG. 2, the third mobile device may steer the third antenna between 4 directional sectors during 4 detection periods.

For example, the third mobile device may steer the third antenna to a directional sector 262 during a detection period 261, and/or the third device may steer the third antenna to a directional sector 264 during a detection period 263.

As shown in FIG. 2, the third device may test the plurality of directional sectors 260 using sounding signal 226.

For example, the third mobile device may test directional sector 262 with directional sector 227 using two repetitions of detection sequence 231, e.g., repetition 232 and repetition 234, during detection period 261. In another example, the third mobile device may steer the first antenna between two directional sectors 270 during two respective detection periods 275.

For example, the third mobile device may steer the third antenna to a directional sector 272 during a detection period 271, and/or the third mobile device may steer the third antenna to a directional sector 274 during a detection period 273.

As shown in FIG. 2, the third mobile device may test the two directional sectors 270 using sounding signal 226. For example, the third device may test a directional sector 272 with directional sector 227 using four repetitions 238 of detection sequence 231.

In some demonstrative embodiments, a mobile device may use two or more beacons to detect the node, for example, if a number of directional sectors of an antenna of the mobile device is greater than the sounding signal length.

In one example, the number of directional sectors of the mobile device may include 16 directional sectors, and the sounding signal length may include 8 sectors. According to this example, the mobile device may use 2 subsequent beacons to detect the node. For example, the mobile device may use 8 directional sectors to detect the node during beacon 205, and 8, e.g., different, directional sectors to detect the node during beacon 207.

In some demonstrative embodiments, the first mobile device may utilize a combination of two or more repetitions of detection sequence 231 to detect the node, for example, if the first mobile device is located far away from the node, e.g., to increase reliability of a detection of the node.

For example, the first mobile device may test directional sector 242 with directional sector 227 using two repetitions of detection sequence 231, e.g., .g., repetition 232 and repetition 234.

In some demonstrative embodiments, the first mobile device may utilize two or more beacons, e.g., beacon 205 and beacon 207, to detect the node and/or to select a directional sector to communicate with the node, for example, if the sounding signal length is lesser than required to test all the directional sectors of the firs mobile device.

In one example, the sounding signal length may be 8, and the first mobile device may test each directional sector of the first antenna with 4 repetitions of detection sequence 231. According to this example, the first device may use 4 subsequent beacons to detect the node, and to select a directional sector to communicate with the node.

In some demonstrative embodiments, the node may indicate to the mobile devices an end of each sounding signal of sounding signals 220.

In one example, the node may indicate the end of sounding signal 222, for example, to ensure that a response, e.g., from one or more of the mobile devices, may be within response period 228, and/or may not overlap with sounding signals 222 and/or 224.

In some demonstrative embodiments, sounding signal 226 may include an indication of an end of sounding signal 226.

In some demonstrative embodiments, sounding signal 226 may use two different detection sequences to enable determining an end of sounding signal 226, e.g., as describe below.

In some demonstrative embodiments, the plurality of repetitions 230 may include a plurality of repetitions of a first detection sequence, e.g., detection sequence 231, followed by a second detection sequence, e.g., detection sequence 233. According to these embodiments, the mobile device may detect the end of sounding signal 226 upon detecting sequence 233.

Reference is made to FIG. 3A, which schematically illustrates a first timing scheme 310 of a transmission from a mobile device to a wireless communication node of a response 304 to a sounding signal 305, in accordance with some demonstrative embodiments. For example, the mobile device may perform the functionality of device 140 (FIG. 1), and/or the node may perform the functionality of device 102 (FIG. 1).

In some demonstrative embodiments, the mobile device may detect a sounding signal 305 at a detection point 302, denoted T₀.

As shown in FIG. 3A, the mobile device may send response 304, for example, after receiving an indication 301, of an end of sounding signal 305, e.g., after receiving sequence 233 (FIG. 2).

As shown in FIG. 3A, response 304 may include a plurality of repetitions of a response sequence 312.

In some demonstrative embodiments, response 304 may include a concatenation of response sequences 312.

In some demonstrative embodiments, response sequence 312 may be different from the detection sequence.

In some demonstrative embodiments, response sequence 312 may be longer than the detection sequence, for example, to increase delectability of response sequence 312, e.g., by device 102 (FIG. 1).

In other embodiments, the length of response sequence 312 may be equal to the length of the detection sequence, for example, for protocol unification purposes. According to these embodiments, response sequence 312 may utilize a code word, e.g., different from the code word of the detection sequence, for example, to prevent other mobile devices to mistakenly responding to response sequence 302.

In some demonstrative embodiments, response 304 may include a large number of response sequences 312, for example, to increase detectability of response 304.

In some demonstrative embodiments, a level of detectability of response 304 may be based, for example, on the length of detection sequence 312 and/or the number of response sequences 312.

In some demonstrative embodiments, the level of detectability of response 304 may be selected, for example, to enable communicating with the node at an increased modulation and coding scheme (MCS), while maintaining an acceptable predefined error level of response 304.

As shown in FIG. 3A, a duration of a response period 316, e.g., between two subsequent sounding signals, may be based on a duration of response 304, a propagation period, denoted Tₐᵢᵣ, between the node and the mobile device, and a processing time at the mobile device, e.g., for switching from a receive mode to a transmit mode, and vice versa.

For example, the duration of response period 316 may be calculated by summing the duration of response 304, two times the propagation period, and the processing time.

Reference is made to FIG. 3B, which schematically illustrates a second timing scheme 320 of a transmission of response 304, in accordance with some demonstrative embodiments.

In some demonstrative embodiments, the mobile device may transmit response 304, for example, even without receiving an indication of the end of sounding signal 304, e.g., indication 301 (FIG. 3A).

In some demonstrative embodiments, the mobile device may transmit response 304 a predefined delay period 308 after detection point T₀.

In some demonstrative embodiments, delay period 308 may be based on a duration of sounding signal 305 and a duration of a detection sequence of sounding signal 305, e.g., a detection sequence 322.

In some demonstrative embodiments, delay period 308 may be equal to or greater than a difference between the duration of sounding signal 305 and the duration of detection sequence 322, for example, if at least one detection sequence is required to detect the node.

As shown in FIG. 3B, a duration of a response period 326 between two subsequent sounding signals may be based on the duration of response 304, the propagation period, the processing time at the node, and delay period 308.

For example, the duration of response period 326 may be calculated by summing the duration of response 304, two times the propagation period, the processing time and the delay period 308.

In some demonstrative embodiments, response period 326 may be longer than response period 316 (FIG. 3A). However, using response period 326 may enable simplifying a structure of the sounding signals, e.g., by not including indication 301 (FIG. 3A).

Referring back to FIG. 1, in some demonstrative embodiments, device 140 may transmit response 149 simultaneously with receiving the plurality of sounding signals, for example, if devices 102 and 140 communicate according to an FDD scheme.

In some demonstrative embodiments, device 102 may not use the response period between the sounding signals, for example, if device 102 uses the FDD scheme.

In some demonstrative embodiments, using multi-directional sounding preamble 212 (FIG. 2) may reduce the time for detecting mobile devices 170 and/or selecting the one or more directional sectors of directional sectors 130 to communicate with mobile devices 170.

In one example, multi-directional sounding preamble 212 (FIG. 2) may enable detecting mobile devices 170 and/or selecting the one or more directional sectors of directional sectors 130 during a single beacon frame. This is in comparison to conventional beam steering and/or searching procedures and/or mechanisms, which require transmitting a full frame, e.g., a DMG frame, including a measurement preamble and the broadcast information, per each directional sector and/or per each mobile device 170.

In another example, using multi-directional sounding preamble 212 (FIG. 2) may enable performing DL and UL training for a mobile device 170, e.g., without performing distinct training for the DL and the UL.

In another example, using multi-directional sounding preamble 212 (FIG. 2) may enable transmitting the broadcast information only after detection of mobile devices 170, while using, for example, the selected directional sectors, e.g., directional sectors 132, 134, and/or 136, e.g., instead of using all directional sectors 130.

In another example, using multi-directional sounding preamble 212 (FIG. 2) may enable transmitting the broadcast information over trained links, e.g., between device 102 and mobile devices 170.

In some demonstrative embodiments, using multi-directional sounding preamble 212 (FIG. 2) may enable device 102 to detect a practical number, e.g., hundreds, of mobile devices, and to determine a selected beam pair to communicate with each mobile device of the mobile devices 170, for example, within a time period of less than 500 us, for example, if the plurality of directional sectors 130 include up to 128 directional sectors, and each device of mobile devices 170 has up to 16 directional sectors.

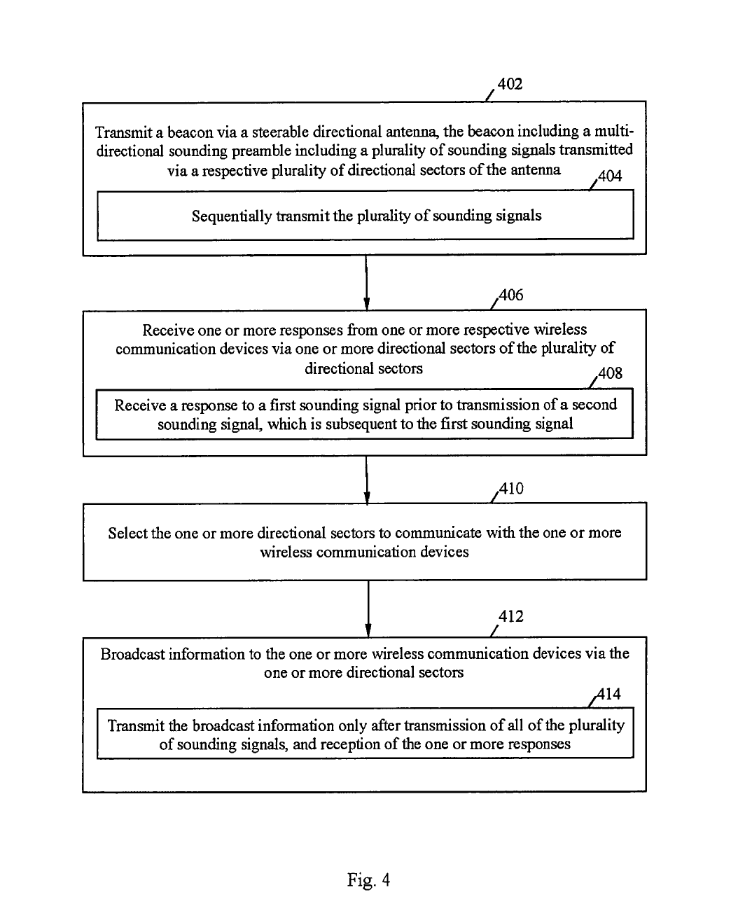

Reference is made to FIG. 4, which schematically illustrates a method of steering a directional antenna, in accordance with some demonstrative embodiments. For example, one or more of the operations of the method of FIG. 4 may be performed by a wireless communication system, e.g., system 100 (FIG. 1); a wireless communication node, e.g., device 102, (FIG. 1); a transmitter, e.g., transmitter 118 (FIG. 1); a receiver, e.g., receiver 116 (FIG. 1) and/or a controller, e.g., controller 124 (FIG. 1).

As indicated at block 402, the method may include transmitting a beacon via the steerable directional antenna, the beacon including a multi-directional sounding preamble including a plurality of sounding signals transmitted via a respective plurality of directional sectors of the antenna. For example, transmitter 118 (FIG. 1) may transmit multi-directional sounding preamble 212 (FIG. 2), e.g., as described above.

As indicated at block 404, transmitting the beacon may include sequentially transmitting the plurality of sounding signals via the respective plurality of directional sectors. For example, transmitter 118 (FIG. 1) may sequentially transmit the plurality of sounding signals 220 (FIG. 2) via the respective plurality of directional sectors 130 (FIG. 1), e.g., as described above.

As indicated at block 406, the method may include receiving one or more responses from one or more respective wireless communication devices via one or more directional sectors of the plurality of directional sectors. For example, receiver 116 (FIG. 1) may receive responses 149, 169 and/or 189 (FIG. 1) from devices 140, 160 and/or 180 (FIG. 1) via one or more directional sectors 132, 134, and/or 136 (FIG. 1), respectively, e.g., as described above.

As indicated at block 408, receiving the one or more responses may include receiving a response to a first sounding signal prior to transmission of a second sounding signal, which is subsequent to the first sounding signal. For example, receiver 116 (FIG. 1) may receive response 149 (FIG. 1) to sounding signal 222 (FIG. 2) prior to the transmission of sounding signal 224 (FIG. 2), which is subsequent to the first sounding signal, e.g., as described above.

As indicated at block 410, the method may include selecting the one or more directional sectors to communicate with the one or more wireless communication devices. For example, controller 124 (FIG. 1) may select directional sectors 132, 134, and/or 136 (FIG. 1), to communicate with devices 140, 160 and/or 180 (FIG. 1), respectively, e.g., as described above.

As indicated at block 412, the method may include broadcasting information to the one or more wireless communication devices via the one or more directional sectors. For example, transmitter 118 (FIG. 1) may broadcast information 214 (FIG. 2) to the one or more wireless communication devices via the one or more directional sectors 132, 134, and/or 136 (FIG. 1), e.g., as described above.

As indicated at block 414, broadcasting the information may include transmitting the broadcast information only after transmission of all of the plurality of sounding signals, and reception of the one or more responses. For example, transmitter 118 (FIG. 1) may broadcast information 214 (FIG. 2) to devices 140, 160 and/or 180 (FIG. 1), only after transmission of all of the plurality of sounding signals 220 (FIG. 2), and reception of responses 149, 169 and/or 189 (FIG. 1) from devices 140, 160 and/or 180 (FIG. 1) via directional sectors 132, 134, and/or 136 (FIG. 1), respectively, e.g., as described above.

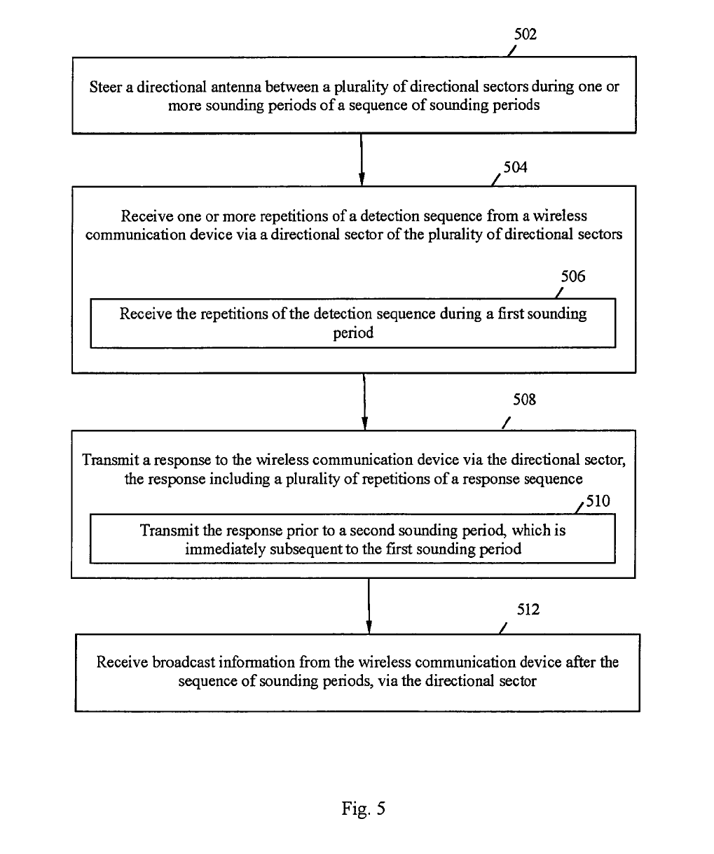

Reference is made to FIG. 5, which schematically illustrates a method of steering a directional antenna, in accordance with some demonstrative embodiments. For example, one or more of the operations of the method of FIG. 5 may be performed by a wireless communication system, e.g., system 100 (FIG. 1); a mobile device, e.g., mobile devices 170 (FIG. 1) and/or mobile device 140 (FIG. 1); a transmitter, e.g., transmitter 148 (FIG. 1); a receiver, e.g., receiver 146 (FIG. 1) and/or a controller, e.g., controller 154 (FIG. 1).

As indicated at block 502, the method may include steering a directional antenna between one or more directional sectors during one or more sounding periods of a sequence of sounding periods. For example, device 140 (FIG. 1) may steer directional antenna 147 (FIG. 1) between directional sectors 145 (FIG. 1) during the one or more sounding periods of the sequence of sounding periods, e.g., as described above.

As indicated at block 504, the method may include receiving one or more repetitions of a detection sequence from a wireless communication device via a directional sector of the plurality of directional sectors. For example, receiver 146 (FIG. 1) may receive the one or more repetitions of detection sequence 231 (FIG. 2) from device 102 (FIG. 1) via directional sector 143 (FIG. 1) e.g., as described above.

As indicated in block 506, receiving one or more repetitions of the detection sequence may include receiving the repetitions of the detection sequence during a first sounding period. For example, receiver 146 (FIG. 1) may receive the one or more repetitions 230 (FIG. 2) of detection sequence 231 (FIG. 2) during the sounding period of sounding signal 222 (FIG. 2), e.g., as described above.

As indicated at block 508, the method may include transmitting a response to the wireless communication device via the directional sector, the response including a plurality of repetitions of a response sequence. For example, transmitter 148 (FIG. 1) may transmit response 149 (FIG. 1) to device 102 (FIG. 1) via directional sector 143 (FIG. 1), e.g., as described above.

As indicated at block 510, transmitting the response may include transmitting the response prior to a second sounding period, which is subsequent, e.g., immediately subsequent, to the first sounding period. For example, transmitter 148 (FIG. 1) may transmit response 149 (FIG. 1) prior to the second sounding period of sounding signal 224 (FIG. 2), e.g., as described above.

As indicated at block 512, the method may include receiving broadcast information from the wireless communication device after the sequence of sounding periods, via the directional sector. For example, receiver 146 (FIG. 1) may receive the broadcast information from device 102 (FIG. 1) via directional sector 143 (FIG. 1), for example, after the sequence of sounding periods 220 (FIG. 2), e.g., as described above.

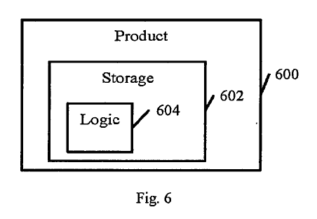

Reference is made to FIG. 6, which schematically illustrates a product of manufacture 600, in accordance with some demonstrative embodiments. Product 600 may include a non-transitory machine-readable storage medium 602 to store logic 604, which may be used, for example, to perform at least part of the functionality of device 102 (FIG. 1), mobile devices 170 (FIG. 1), transmitters 118 and/or 148 (FIG. 1), receivers 116 and/or 146 (FIG. 1), controllers 144 and/or 124 (FIG. 1), and/or to perform one or more operations of the methods of FIGS. 4 and/or 5. The phrase “non-transitory machine-readable medium” is directed to include all computer-readable media, with the sole exception being a transitory propagating signal.

In some demonstrative embodiments, product 600 and/or machine-readable storage medium 602 may include one or more types of computer-readable storage media capable of storing data, including volatile memory, non-volatile memory, removable or non-removable memory, erasable or non-erasable memory, writeable or re-writeable memory, and the like. For example, machine-readable storage medium 602 may include, RAM, DRAM, Double-Data-Rate DRAM (DDR-DRAM), SDRAM, static RAM (SRAM), ROM, programmable ROM (PROM), erasable programmable ROM (EPROM), electrically erasable programmable ROM (EEPROM), Compact Disk ROM (CD-ROM), Compact Disk Recordable (CD-R), Compact Disk Rewriteable (CD-RW), flash memory (e.g., NOR or NAND flash memory), content addressable memory (CAM), polymer memory, phase-change memory, ferroelectric memory, silicon-oxide-nitride-oxide-silicon (SONOS) memory, a disk, a floppy disk, a hard drive, an optical disk, a magnetic disk, a card, a magnetic card, an optical card, a tape, a cassette, and the like. The computer-readable storage media may include any suitable media involved with downloading or transferring a computer program from a remote computer to a requesting computer carried by data signals embodied in a carrier wave or other propagation medium through a communication link, e.g., a modem, radio or network connection.

In some demonstrative embodiments, logic 604 may include instructions, data, and/or code, which, if executed by a machine, may cause the machine to perform a method, process and/or operations as described herein. The machine may include, for example, any suitable processing platform, computing platform, computing device, processing device, computing system, processing system, computer, processor, or the like, and may be implemented using any suitable combination of hardware, software, firmware, and the like.

In some demonstrative embodiments, logic 604 may include, or may be implemented as, software, a software module, an application, a program, a subroutine, instructions, an instruction set, computing code, words, values, symbols, and the like. The instructions may include any suitable type of code, such as source code, compiled code, interpreted code, executable code, static code, dynamic code, and the like. The instructions may be implemented according to a predefined computer language, manner or syntax, for instructing a processor to perform a certain function. The instructions may be implemented using any suitable high-level, low-level, object-oriented, visual, compiled and/or interpreted programming language, such as C, C++, Java, BASIC, Matlab, Pascal, Visual BASIC, assembly language, machine code, and the like.

### EXAMPLES

The following examples pertain to further embodiments.

### Examples

Example 1 includes an apparatus comprising a transmitter to transmit a beacon via a steerable directional antenna, the beacon including a multi-directional sounding preamble including a plurality of sounding signals transmitted via a respective plurality of directional sectors of the antenna, each sounding signal including a plurality of repetitions of a detection sequence; a receiver to receive one or more responses from one or more respective wireless communication devices via one or more directional sectors of the plurality of directional sectors; and a controller to select the one or more directional sectors to communicate with the one or more wireless communication devices.

Example 2 includes the subject matter of Example 1, and optionally, wherein the transmitter is to sequentially transmit the plurality of sounding signals, and the receiver is to receive a response to a first sounding signal prior to transmission of a second sounding signal, which is subsequent to the first sounding signal.

Example 3 includes the subject matter of Example 2, and optionally, wherein the receiver is to receive the response during a response period between transmission of the first sounding signal and transmission of the second sounding signal.

Example 4 includes the subject matter of any one of Examples 1-3, and optionally, wherein the transmitter is to broadcast information to the one or more wireless communication devices via the one or more directional sectors.

Example 5 includes the subject matter of any one of Examples 1-4, and optionally, wherein the transmitter is to transmit broadcast information only after transmission of all of the plurality of sounding signals, and reception of the one or more responses.

Example 6 includes the subject matter of any one of Examples 1-5, and optionally, wherein the sounding signal includes an indication of an end of the sounding signal.

Example 7 includes the subject matter of any one of Examples 1-6, and optionally, wherein the plurality of repetitions of the detection sequence comprises a plurality of repetitions of a first detection sequence, the sounding signal including a second detection sequence, different from the first detection sequence, following the plurality of repetitions of the first detection sequence.

Example 8 includes the subject matter of any one of Examples 1-7, and optionally, wherein each response of the responses includes a plurality of repetitions of a response sequence.

Example 9 includes the subject matter of Example 8, and optionally, wherein the response sequence is different from the detection sequence.

Example 10 includes the subject matter of Example 8 or 9, and optionally, wherein the response sequence is longer than the detection sequence.

Example 11 includes the subject matter of any one of Examples 1-10, and optionally, wherein the transmitter is to transmit the beacon over a Directional Multi-Gigabit (DMG) wireless communication channel.

Example 12 includes a wireless communication device comprising a steerable directional antenna; a memory; a processor; a transmitter to transmit a beacon via the steerable directional antenna, the beacon including a multi-directional sounding preamble including a plurality of sounding signals transmitted via a respective plurality of directional sectors of the antenna, each sounding signal including a plurality of repetitions of a detection sequence; a receiver to receive one or more responses from one or more respective wireless communication devices via one or more directional sectors of the plurality of directional sectors; and a controller to select the one or more directional sectors to communicate with the one or more wireless communication devices.

Example 13 includes the subject matter of Example 12, and optionally, wherein the transmitter is to sequentially transmit the plurality of sounding signals, and the receiver is to receive a response to a first sounding signal prior to transmission of a second sounding signal, which is subsequent to the first sounding signal.

Example 14 includes the subject matter of Example 13, and optionally, wherein the receiver is to receive the response during a response period between transmission of the first sounding signal and transmission of the second sounding signal.

Example 15 includes the subject matter of any one of Examples 12-14, and optionally, wherein the transmitter is to broadcast information to the one or more wireless communication devices via the one or more directional sectors.

Example 16 includes the subject matter of any one of Examples 12-15, and optionally, wherein the transmitter is to transmit broadcast information only after transmission of all of the plurality of sounding signals, and reception of the one or more responses.

Example 17 includes the subject matter of any one of Examples 12-16, and optionally, wherein the sounding signal includes an indication of an end of the sounding signal.

Example 18 includes the subject matter of any one of Examples 12-17, and optionally, wherein the plurality of repetitions of the detection sequence comprises a plurality of repetitions of a first detection sequence, the sounding signal including a second detection sequence, different from the first detection sequence, following the plurality of repetitions of the first detection sequence.

Example 19 includes the subject matter of any one of Examples 12-18, and optionally, wherein each response of the responses includes a plurality of repetitions of a response sequence.

Example 20 includes the subject matter of Example 19, and optionally, wherein the response sequence is different from the detection sequence.

Example 21 includes the subject matter of Example 19 or 20, and optionally, wherein the response sequence is longer than the detection sequence.

Example 22 includes the subject matter of any one of Examples 12-21, and optionally, wherein the transmitter is to transmit the beacon over a Directional Multi-Gigabit (DMG) wireless communication channel.

Example 23 includes a method comprising transmitting a beacon via a steerable directional antenna, the beacon including a multi-directional sounding preamble including a plurality of sounding signals transmitted via a respective plurality of directional sectors of the antenna, each sounding signal including a plurality of repetitions of a detection sequence; receiving one or more responses from one or more respective wireless communication devices via one or more directional sectors of the plurality of directional sectors; and selecting the one or more directional sectors to communicate with the one or more wireless communication devices.

Example 24 includes the subject matter of Example 23, and optionally, comprising sequentially transmitting the plurality of sounding signals, and receiving a response to a first sounding signal prior to transmission of a second sounding signal, which is subsequent to the first sounding signal.

Example 25 includes the subject matter of Example 24, and optionally, comprising receiving the response during a response period between transmission of the first sounding signal and transmission of the second sounding signal.

Example 26 includes the subject matter of any one of Examples 23-25, and optionally, comprising broadcasting information to the one or more wireless communication devices via the one or more directional sectors.

Example 27 includes the subject matter of any one of Examples 23-26, and optionally, comprising transmitting broadcast information only after transmission of all of the plurality of sounding signals, and reception of the one or more responses.

Example 28 includes the subject matter of any one of Examples 23-27, and optionally, wherein the sounding signal includes an indication of an end of the sounding signal.

Example 29 includes the subject matter of any one of Examples 23-28, and optionally, wherein the plurality of repetitions of the detection sequence comprises a plurality of repetitions of a first detection sequence, the sounding signal including a second detection sequence, different from the first detection sequence, following the plurality of repetitions of the first detection sequence.

Example 30 includes the subject matter of any one of Examples 23-29, and optionally, wherein each response of the responses includes a plurality of repetitions of a response sequence.

Example 31 includes the subject matter of Example 30, and optionally, wherein the response sequence is different from the detection sequence.

Example 32 includes the subject matter of Example 30 or 31, and optionally, wherein the response sequence is longer than the detection sequence.

Example 33 includes the subject matter of any one of Examples 23-32, and optionally, comprising transmitting the beacon over a Directional Multi-Gigabit (DMG) wireless communication channel.

Example 34 includes a product including one or more tangible computer-readable non-transitory storage media comprising computer-executable instructions operable to, when executed by at least one computer processor, enable the at least one computer processor to implement a method comprising transmitting a beacon via a steerable directional antenna, the beacon including a multi-directional sounding preamble including a plurality of sounding signals transmitted via a respective plurality of directional sectors of the antenna, each sounding signal including a plurality of repetitions of a detection sequence; receiving one or more responses from one or more respective wireless communication devices via one or more directional sectors of the plurality of directional sectors; and selecting the one or more directional sectors to communicate with the one or more wireless communication devices.

Example 35 includes the subject matter of Example 34, and optionally, wherein the method comprises sequentially transmitting the plurality of sounding signals, and receiving a response to a first sounding signal prior to transmission of a second sounding signal, which is subsequent to the first sounding signal.

Example 36 includes the subject matter of Example 35, and optionally, wherein the method comprises receiving the response during a response period between transmission of the first sounding signal and transmission of the second sounding signal.

Example 37 includes the subject matter of any one of Examples 34-36, and optionally, wherein the method comprises broadcasting information to the one or more wireless communication devices via the one or more directional sectors.

Example 38 includes the subject matter of any one of Examples 34-37, and optionally, wherein the method comprises transmitting broadcast information only after transmission of all of the plurality of sounding signals, and reception of the one or more responses.

Example 39 includes the subject matter of any one of Examples 34-38, and optionally, wherein the sounding signal includes an indication of an end of the sounding signal.

Example 40 includes the subject matter of any one of Examples 34-39, and optionally, wherein the plurality of repetitions of the detection sequence comprises a plurality of repetitions of a first detection sequence, the sounding signal including a second detection sequence, different from the first detection sequence, following the plurality of repetitions of the first detection sequence.

Example 41 includes the subject matter of any one of Examples 34-40, and optionally, wherein each response of the responses includes a plurality of repetitions of a response sequence.

Example 42 includes the subject matter of Example 41, and optionally, wherein the response sequence is different from the detection sequence.

Example 43 includes the subject matter of Example 41 or 42, and optionally, wherein the response sequence is longer than the detection sequence.

Example 44 includes the subject matter of any one of Examples 34-43, and optionally, wherein the method comprises transmitting the beacon over a Directional Multi-Gigabit (DMG) wireless communication channel.

Example 45 includes an apparatus comprising means for transmitting a beacon via a steerable directional antenna, the beacon including a multi-directional sounding preamble including a plurality of sounding signals transmitted via a respective plurality of directional sectors of the antenna, each sounding signal including a plurality of repetitions of a detection sequence; means for receiving one or more responses from one or more respective wireless communication devices via one or more directional sectors of the plurality of directional sectors; and means for selecting the one or more directional sectors to communicate with the one or more wireless communication devices.

Example 46 includes the subject matter of Example 45, and optionally, comprising means for sequentially transmitting the plurality of sounding signals, and means for receiving a response to a first sounding signal prior to transmission of a second sounding signal, which is subsequent to the first sounding signal.

Example 47 includes the subject matter of Example 46, and optionally, comprising means for receiving the response during a response period between transmission of the first sounding signal and transmission of the second sounding signal.

Example 48 includes the subject matter of any one of Examples 45-47, and optionally, comprising means for broadcasting information to the one or more wireless communication devices via the one or more directional sectors.

Example 49 includes the subject matter of any one of Examples 45-48, and optionally, comprising means for transmitting broadcast information only after transmission of all of the plurality of sounding signals, and reception of the one or more responses.

Example 50 includes the subject matter of any one of Examples 45-49, and optionally, wherein the sounding signal includes an indication of an end of the sounding signal.

Example 51 includes the subject matter of any one of Examples 45-50, and optionally, wherein the plurality of repetitions of the detection sequence comprises a plurality of repetitions of a first detection sequence, the sounding signal including a second detection sequence, different from the first detection sequence, following the plurality of repetitions of the first detection sequence.

Example 52 includes the subject matter of any one of Examples 45-51, and optionally, wherein each response of the responses includes a plurality of repetitions of a response sequence.

Example 53 includes the subject matter of Example 52, and optionally, wherein the response sequence is different from the detection sequence.

Example 54 includes the subject matter of Example 52 or 53, and optionally, wherein the response sequence is longer than the detection sequence.

Example 55 includes the subject matter of any one of Examples 45-54, and optionally, comprising means for transmitting the beacon over a Directional Multi-Gigabit (DMG) wireless communication channel.

Example 56 includes an apparatus comprising a controller to steer a directional antenna between one or more directional sectors during one or more sounding periods of a sequence of sounding periods; a receiver to receive one or more repetitions of a detection sequence from a wireless communication device via a directional sector of the one or more directional sectors; and a transmitter to transmit a response to the wireless communication device via the directional sector, the response including a plurality of repetitions of a response sequence, wherein, after the sequence of sounding periods, the receiver is to receive broadcast information from the wireless communication device via the directional sector.

Example 57 includes the subject matter of Example 56, and optionally, wherein the receiver is to receive the repetitions of the detection sequence during a first sounding period, and the transmitter is to transmit the response prior to a second sounding period, which is immediately subsequent to the first sounding period.

Example 58 includes the subject matter of Example 57, and optionally, wherein the transmitter is to transmit the response during a response period between the first and second sounding periods.

Example 59 includes the subject matter of any one of Examples 56-58, and optionally, wherein the receiver is to receive an indication of an end of a sounding signal including the one or more repetitions of the detection sequence, and the transmitter is to transmit the response after receipt of the indication.

Example 60 includes the subject matter of any one of Examples 56-59, and optionally, wherein the transmitter is to transmit the response a predefined delay period after receipt of the one or more repetitions of the detection sequence.

Example 61 includes the subject matter of Example 60, and optionally, wherein the delay period is based on a sounding period duration and a duration of the detection sequence.

Example 62 includes the subject matter of Example 61, and optionally, wherein the delay period is equal to or greater than a difference between the sounding period duration and the duration of the detection sequence.

Example 63 includes the subject matter of any one of Examples 56-62, and optionally, wherein the response sequence is different from the detection sequence.

Example 64 includes the subject matter of any one of Examples 56-63, and optionally, wherein the response sequence is longer than the detection sequence.

Example 65 includes the subject matter of any one of Examples 56-64, and optionally, wherein the receiver is to receive the one or more repetitions of the detection sequence over a Directional Multi-Gigabit (DMG) wireless communication channel.

Example 66 includes a wireless communication device comprising a directional antenna; a memory; a processor; a controller to steer the directional antenna between one or more directional sectors during one or more sounding periods of a sequence of sounding periods; a receiver to receive one or more repetitions of a detection sequence from a wireless communication device via a directional sector of the one or more directional sectors; and a transmitter to transmit a response to the wireless communication device via the directional sector, the response including a plurality of repetitions of a response sequence, wherein, after the sequence of sounding periods, the receiver is to receive broadcast information from the wireless communication device via the directional sector.

Example 67 includes the subject matter of Example 66, and optionally, wherein the receiver is to receive the repetitions of the detection sequence during a first sounding period, and the transmitter is to transmit the response prior to a second sounding period, which is immediately subsequent to the first sounding period.

Example 68 includes the subject matter of Example 67, and optionally, wherein the transmitter is to transmit the response during a response period between the first and second sounding periods.

Example 69 includes the subject matter of any one of Examples 66-68, and optionally, wherein the receiver is to receive an indication of an end of a sounding signal including the one or more repetitions of the detection sequence, and the transmitter is to transmit the response after receipt of the indication.

Example 70 includes the subject matter of any one of Examples 66-69, and optionally, wherein the transmitter is to transmit the response a predefined delay period after receipt of the one or more repetitions of the detection sequence.

Example 71 includes the subject matter of Example 70, and optionally, wherein the delay period is based on a sounding period duration and a duration of the detection sequence.

Example 72 includes the subject matter of Example 71, and optionally, wherein the delay period is equal to or greater than a difference between the sounding period duration and the duration of the detection sequence.

Example 73 includes the subject matter of any one of Examples 66-72, and optionally, wherein the response sequence is different from the detection sequence.

Example 74 includes the subject matter of any one of Examples 66-73, and optionally, wherein the response sequence is longer than the detection sequence.

Example 75 includes the subject matter of any one of Examples 66-74, and optionally, wherein the receiver is to receive the one or more repetitions of the detection sequence over a Directional Multi-Gigabit (DMG) wireless communication channel.

Example 76 includes a method comprising steering a directional antenna between one or more directional sectors during one or more sounding periods of a sequence of sounding periods; receiving one or more repetitions of a detection sequence from a wireless communication device via a directional sector of the one or more directional sectors; transmitting a response to the wireless communication device via the directional sector, the response including a plurality of repetitions of a response sequence; and after the sequence of sounding periods, receiving broadcast information from the wireless communication device via the directional sector.

Example 77 includes the subject matter of Example 76, and optionally, comprising receiving the repetitions of the detection sequence during a first sounding period, and transmitting the response prior to a second sounding period, which is immediately subsequent to the first sounding period.

Example 78 includes the subject matter of Example 77, and optionally, comprising transmitting the response during a response period between the first and second sounding periods.

Example 79 includes the subject matter of any one of Examples 76-78, and optionally, comprising receiving an indication of an end of a sounding signal including the one or more repetitions of the detection sequence, and transmitting the response after receipt of the indication.

Example 80 includes the subject matter of any one of Examples 76-79, and optionally, comprising transmitting the response a predefined delay period after receipt of the one or more repetitions of the detection sequence.

Example 81 includes the subject matter of Example 80, and optionally, wherein the delay period is based on a sounding period duration and a duration of the detection sequence.

Example 82 includes the subject matter of Example 81, and optionally, wherein the delay period is equal to or greater than a difference between the sounding period duration and the duration of the detection sequence.

Example 83 includes the subject matter of any one of Examples 76-82, and optionally, wherein the response sequence is different from the detection sequence.

Example 84 includes the subject matter of any one of Examples 76-83, and optionally, wherein the response sequence is longer than the detection sequence.

Example 85 includes the subject matter of any one of Examples 76-84, and optionally, comprising receiving the one or more repetitions of the detection sequence over a Directional Multi-Gigabit (DMG) wireless communication channel.

Example 86 includes a product including one or more tangible computer-readable non-transitory storage media comprising computer-executable instructions operable to, when executed by at least one computer processor, enable the at least one computer processor to implement a method comprising steering a directional antenna between one or more directional sectors during one or more sounding periods of a sequence of sounding periods; receiving one or more repetitions of a detection sequence from a wireless communication device via a directional sector of the one or more directional sectors; transmitting a response to the wireless communication device via the directional sector, the response including a plurality of repetitions of a response sequence; and after the sequence of sounding periods, receiving broadcast information from the wireless communication device via the directional sector.

Example 87 includes the subject matter of Example 86, and optionally, wherein the method comprises receiving the repetitions of the detection sequence during a first sounding period, and transmitting the response prior to a second sounding period, which is immediately subsequent to the first sounding period.

Example 88 includes the subject matter of Example 87, and optionally, wherein the method comprises transmitting the response during a response period between the first and second sounding periods.

Example 89 includes the subject matter of any one of Examples 86-88, and optionally, wherein the method comprises receiving an indication of an end of a sounding signal including the one or more repetitions of the detection sequence, and transmitting the response after receipt of the indication.

Example 90 includes the subject matter of any one of Examples 86-89, and optionally, wherein the method comprises transmitting the response a predefined delay period after receipt of the one or more repetitions of the detection sequence.

Example 91 includes the subject matter of Example 90, and optionally, wherein the delay period is based on a sounding period duration and a duration of the detection sequence.

Example 92 includes the subject matter of Example 91, and optionally, wherein the delay period is equal to or greater than a difference between the sounding period duration and the duration of the detection sequence.

Example 93 includes the subject matter of any one of Examples 86-92, and optionally, wherein the response sequence is different from the detection sequence.

Example 94 includes the subject matter of any one of Examples 86-93, and optionally, wherein the response sequence is longer than the detection sequence.

Example 95 includes the subject matter of any one of Examples 86-94, and optionally, wherein the method comprises receiving the one or more repetitions of the detection sequence over a Directional Multi-Gigabit (DMG) wireless communication channel.

Example 96 includes an apparatus comprising means for steering a directional antenna between one or more directional sectors during one or more sounding periods of a sequence of sounding periods; means for receiving one or more repetitions of a detection sequence from a wireless communication device via a directional sector of the one or more directional sectors; means for transmitting a response to the wireless communication device via the directional sector, the response including a plurality of repetitions of a response sequence; and means for receiving broadcast information from the wireless communication device via the directional sector, after the sequence of sounding periods.

Example 97 includes the subject matter of Example 96, and optionally, comprising means for receiving the repetitions of the detection sequence during a first sounding period, and means for transmitting the response prior to a second sounding period, which is immediately subsequent to the first sounding period.

Example 98 includes the subject matter of Example 97, and optionally, comprising means for transmitting the response during a response period between the first and second sounding periods.

Example 99 includes the subject matter of any one of Examples 96-98, and optionally, comprising means for receiving an indication of an end of a sounding signal including the one or more repetitions of the detection sequence, and means for transmitting the response after receipt of the indication.

Example 100 includes the subject matter of any one of Examples 96-99, and optionally, comprising means for transmitting the response a predefined delay period after receipt of the one or more repetitions of the detection sequence.

Example 101 includes the subject matter of Example 100, and optionally, wherein the delay period is based on a sounding period duration and a duration of the detection sequence.

Example 102 includes the subject matter of Example 101, and optionally, wherein the delay period is equal to or greater than a difference between the sounding period duration and the duration of the detection sequence.

Example 103 includes the subject matter of any one of Examples 96-102, and optionally, wherein the response sequence is different from the detection sequence.

Example 104 includes the subject matter of any one of Examples 96-103, and optionally, wherein the response sequence is longer than the detection sequence.

Example 105 includes the subject matter of any one of Examples 96-104, and optionally, comprising means for receiving the one or more repetitions of the detection sequence over a Directional Multi-Gigabit (DMG) wireless communication channel.

Functions, operations, components and/or features described herein with reference to one or more embodiments, may be combined with, or may be utilized in combination with, one or more other functions, operations, components and/or features described herein with reference to one or more other embodiments, or vice versa.

While certain features have been illustrated and described herein, many modifications, substitutions, changes, and equivalents may occur to those skilled in the art. It is, therefore, to be understood that the appended claims are intended to cover all such modifications and changes as fall within the true spirit of the invention.

1.-25. (canceled)

26. An apparatus comprising:
a transmitter to transmit a beacon via a steerable directional antenna, the beacon including a multi-directional sounding preamble including a plurality of sounding signals transmitted via a respective plurality of directional sectors of said antenna, each sounding signal including a plurality of repetitions of a detection sequence;
a receiver to receive one or more responses from one or more respective wireless communication devices via one or more directional sectors of said plurality of directional sectors; and
a controller to select the one or more directional sectors to communicate with the one or more wireless communication devices.

27. The apparatus of claim 26, wherein said transmitter is to sequentially transmit said plurality of sounding signals, and said receiver is to receive a response to a first sounding signal prior to transmission of a second sounding signal, which is subsequent to said first sounding signal.

28. The apparatus of claim 27, wherein the receiver is to receive said response during a response period between transmission of said first sounding signal and transmission of said second sounding signal.

29. The apparatus of claim 26, wherein said transmitter is to broadcast information to the one or more wireless communication devices via the one or more directional sectors.

30. The apparatus of claim 26, wherein said transmitter is to transmit broadcast information only after transmission of all of said plurality of sounding signals, and reception of the one or more responses.

31. The apparatus of claim 26, wherein the sounding signal includes an indication of an end of the sounding signal.

32. The apparatus of claim 26, wherein the plurality of repetitions of the detection sequence comprises a plurality of repetitions of a first detection sequence, the sounding signal including a second detection sequence, different from the first detection sequence, following the plurality of repetitions of the first detection sequence.

33. The apparatus of claim 26, wherein each response of said responses includes a plurality of repetitions of a response sequence.

34. The apparatus of claim 26, wherein said transmitter is to transmit said beacon over a Directional Multi-Gigabyte (DMG) wireless communication channel.

35. The apparatus of claim 26 including:
said steerable directional antenna;
a memory; and
a processor.

36. An apparatus comprising:
a controller to steer a directional antenna between one or more directional sectors during one or more sounding periods of a sequence of sounding periods;
a receiver to receive one or more repetitions of a detection sequence from a wireless communication device via a directional sector of the one or more directional sectors; and
a transmitter to transmit a response to the wireless communication device via the directional sector, the response including a plurality of repetitions of a response sequence,
wherein, after said sequence of sounding periods, said receiver is to receive broadcast information from the wireless communication device via the directional sector.

37. The apparatus of claim 36, wherein said receiver is to receive said repetitions of the detection sequence during a first sounding period, and said transmitter is to transmit said response prior to a second sounding period, which is immediately subsequent to said first sounding period.

38. The apparatus of claim 37, wherein said transmitter is to transmit said response during a response period between said first and second sounding periods.

39. The apparatus of claim 36, wherein said receiver is to receive an indication of an end of a sounding signal including the one or more repetitions of the detection sequence, and said transmitter is to transmit said response after receipt of said indication.

40. The apparatus of claim 36, wherein said transmitter is to transmit said response a predefined delay period after receipt of the one or more repetitions of the detection sequence.

41. The apparatus of claim 36, wherein said delay period is based on a sounding period duration and a duration of said detection sequence.

42. The apparatus of claim 36, wherein said response sequence is different from said detection sequence.

43. The apparatus of claim 36, wherein said response sequence is longer than said detection sequence.

44. The apparatus of claim 36 being a mobile device including:
said directional antenna;
a memory; and
a processor.

45. A method comprising:
steering a directional antenna between one or more directional sectors during one or more sounding periods of a sequence of sounding periods;
receiving one or more repetitions of a detection sequence from a wireless communication device via a directional sector of the one or more directional sectors;
transmitting a response to the wireless communication device via the directional sector, the response including a plurality of repetitions of a response sequence; and
after said sequence of sounding periods, receiving broadcast information from the wireless communication device via the directional sector.

46. The method of claim 45 comprising receiving said repetitions of the detection sequence during a first sounding period, and transmitting said response prior to a second sounding period, which is immediately subsequent to said first sounding period.

47. The method of claim 45 comprising transmitting said response a predefined delay period after receipt of the one or more repetitions of the detection sequence.

48. A product including one or more tangible computer-readable non-transitory storage media comprising computer-executable instructions operable to, when executed by at least one computer processor, enable the at least one computer processor to implement a method comprising:
transmitting a beacon via a steerable directional antenna, the beacon including a multi-directional sounding preamble including a plurality of sounding signals transmitted via a respective plurality of directional sectors of said antenna, each sounding signal including a plurality of repetitions of a detection sequence;
receiving one or more responses from one or more respective wireless communication devices via one or more directional sectors of said plurality of directional sectors; and
selecting the one or more directional sectors to communicate with the one or more wireless communication devices.

49. The product of claim 48, wherein said method comprises sequentially transmitting said plurality of sounding signals, and receiving a response to a first sounding signal prior to transmission of a second sounding signal, which is subsequent to said first sounding signal.

50. The product of claim 48, wherein said method comprises broadcasting information to the one or more wireless communication devices via the one or more directional sectors.
